(19) United States
(12) Patent Application Publication
(10) Pub. No.: US 2008/0024450 A1
(43) Pub. Date: Jan. 31, 2008

(54) A SYSTEM FOR COMMAND-LINE KEYBOARD BUFFER VIEWING AND EDITING

(75) Inventors: Scott J. Broussard, Cedar Park, TX (US); Steven D. Clay, Pflugerville, TX (US); Eduardo N. Spring, Round Rock, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,770

(22) Filed: Jul. 28, 2006

(51) Int. Cl. G09G 5/00

(52) U.S. Cl. 345/168

(57) ABSTRACT

A system for processing and displaying command-line input data is described. The system includes a keyboard buffer configured to store a pending command entered in a command line interface such that the entered pending command may be executed shortly thereafter. The system also includes a display that houses a screen. The display is configured to display the entered pending command in the command-line interface on the screen, such that a user may review, validate and edit the entered pending command prior to execution. The system also includes a central processing unit. The central processing unit houses the processor. The keyboard buffer, the command-line interface and the display are operably associated with the processor. The processor is configured to interpret and execute the pending command stored in the keyboard buffer.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to command-line processing and, more particularly, to displaying the commands entered in a command-line interface.

2. Description of the Invention

When executing a program at a command-line interface, a keyboard will accept input even though the characters are not displayed on a screen. Once the current command finishes, the characters previously typed are now displayed and potentially executed. This is problematic, however, as there may be mistyped characters in the buffered command. It is especially problematic if a user presses return in the buffer, because an invalid command is submitted which at minimum will require the user to retype the command correctly, and may even result in data loss.

Thus, there is a need for the user to be able to view the characters of the entered pending command prior to execution of the pending command such that the user may validate the pending command prior to the current command completing execution.

### SUMMARY OF THE INVENTION

The shortcomings of the prior art are overcome and additional advantages are provided through the provision of a system for processing and displaying command-line input data. The system includes a keyboard buffer configured to store a pending command entered in a command-line interface such that the entered pending command may be executed shortly thereafter. The system further includes a display housing a screen. The display is configured to display the entered pending command in the command-line interface on the screen such that a user may review, validate and edit the entered pending command prior to execution. The system further includes a central processing unit housing a processor. The keyboard buffer, the command-line interface and the display are operably associated with the processor. The processor is configured to interpret and execute the pending command stored in the keyboard buffer.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a system for processing and displaying command-line input data.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for processing and displaying command-line input data;

FIG. 2 illustrates one example of a screen view of the system shown in FIG. 1; and

FIG. 3 illustrates one example of an alternative screen view of the system shown in FIG. 1.

The detailed description explains an exemplary embodiment of the invention, together with advantages and features, by way of example with reference to the drawings.

### DETAILED DESCRIPTION OF THE INVENTION

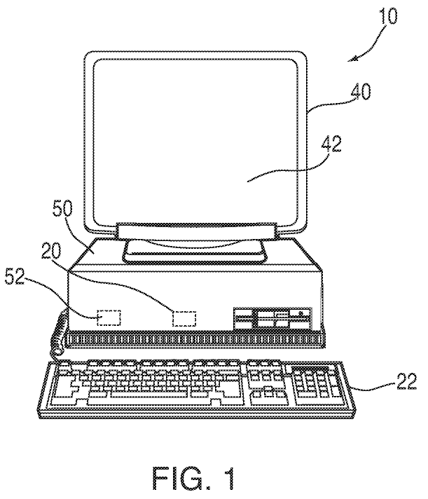

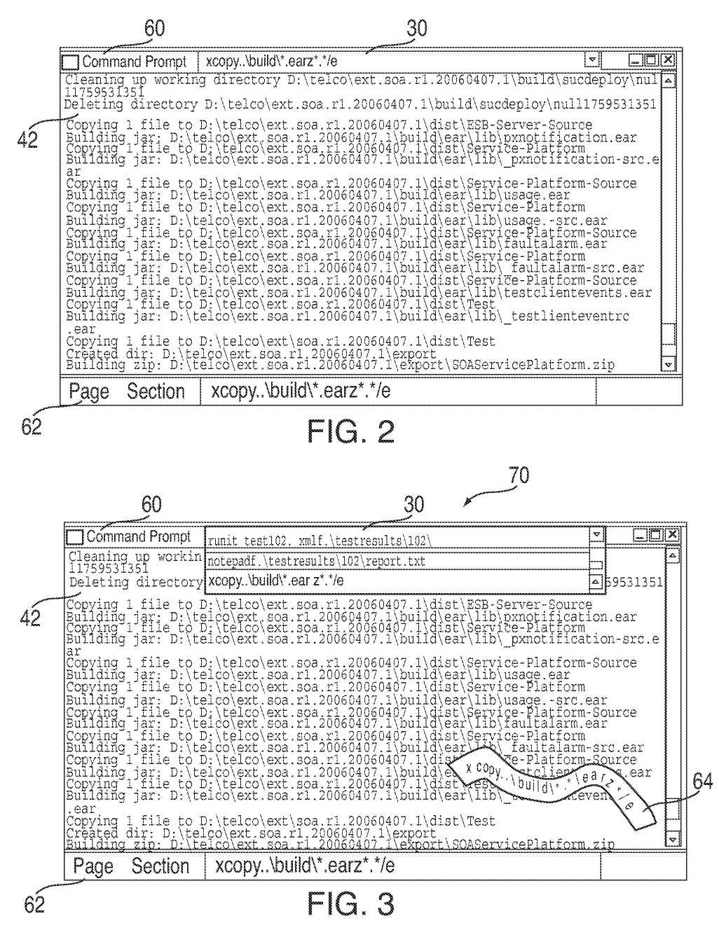

Referring to FIGS. 1-3, a system 10 for processing and displaying command-line input data, is shown. The system 10 includes a keyboard buffer 20 that is configured to store a pending command entered in a command-line interface 30, such that the entered pending command may be executed shortly thereafter. The command-line interface 30 includes a drop-down list 70.

The drop-down list 70 allows all of the pending commands to be viewed on a screen 42 with each pending command being separated on the drop-down list 70. Selecting a specific pending command allows the pending command to be edited. The pending command remains in the forefront of the drop-down list 70 until the pending command is executed. Then the next command moves up in order into the forefront of the drop-down list and remains there until it is executed. The pending command may be inserted into the drop-down list 70 such that the pending command precedes another command already in the drop-down list 70, and both commands are subsequently separated into separate commands. Additionally, the drop-down list 70 provides historical and contextual data that is saved until the user deletes the data, such data includes the directory the user was in when the user typed the command. Also, the environment variable at the time the command was entered and the time the command was entered may be displayed.

For example and not meant to be limiting, for history the drop-down list 70 may use a color scheme or other indicator to identify commands that have been executed. The executed commands may be green, while the current command being executed is black. The future commands that shall be executed may be shown on the screen 42 with a light blue background. As the user highlights each item another window could display on the user's screen 42 that shows the contextual and/or historical information regarding the command. Historical information could include the same example information previously explained for the contextual information. Items such as when the command executed and return codes encountered as a result of the execution may easily be added.

The keyboard buffer's 20 pending command is displayable in at least one of the following forms: (i) a title bar 60, (ii) a status bar, and (iii) a flyover object, all of which are viewable on the screen 42. The keyboard buffer 20 is further configured to accept multiple pending commands that are entered in the command-line interface 30 and separate the pending commands into separate entries. The keyboard buffer's 20 pending command(s) are also editable. Editing the pending command in the keyboard buffer 20 results in the pending command being frozen such that the program intended to execute the pending command cannot retrieve the incomplete pending command.

The system 10 further includes a display 40. The screen 42 is disposed in the display 40. The display 40 is configured to display the entered pending command in the command-line interface 30 on the screen 42, such that the user may review, validate and edit the entered pending command.

The system 10 further includes a central processing unit 50. The central processing unit 50 houses a processor 52 that is configured to interpret and execute the pending command stored in the keyboard buffer 20. The keyboard buffer 20, the command-line interface 30 and the display 50 are all operably associated with the processor 50.

The system 10 further includes a keyboard 22. The keyboard 22 is operably associated with the processor 50 and is configured to enter the pending command into the command-line interface 30. The pending command is editable via the keyboard 22 by selecting the pending command in the drop-down list 70 and performing at least one of: (i) selecting the delete option on the keyboard 22, and (ii) selecting the backspace option on the keyboard 22, such that the characters of the pending command are erased.

Furthermore, the pending command may be entered via the keyboard 22 by at least one of the following functions of: (i) dragging and dropping the pending command to and from the command-line interface, and (ii) cutting and pasting the pending command from one drop-down list 70 location to another drop-down list 70 location.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for processing and displaying command-line input data, comprising:
a keyboard buffer configured to store a pending command entered in a command-line interface such that the entered pending command may be executed shortly thereafter;
a display housing a screen, the display configured to display the entered pending command in the command-line interface on the screen such that a user may review, validate and edit the entered pending command prior to execution; and
a central processing unit housing a processor, the keyboard buffer, the command-line interface and the display being operably associated with the processor, the processor being configured to interpret and execute the pending command stored in the keyboard buffer.

2. The system of claim 1, further including a keyboard operably associated with the processor, the keyboard configured to enter the pending command into the command-line interface.

3. The system of claim 2, wherein the keyboard buffer pending command is displayable in at least one of (i) a title-bar, (ii) a status bar, and (iii) a flyover object viewable on the screen.

4. The system of claim 3, wherein the keyboard buffer is further configured to accept multiple pending commands entered in the command-line interface and separate the pending commands into separate entries.

5. The system of claim 4, wherein the keyboard buffer pending command is editable, editing the pending command in the keyboard buffer results in the pending command being frozen such that the program intended to execute the pending command cannot retrieve the incomplete pending command.

6. The system of claim 5, wherein the command-line interface includes a drop-down list, the drop-down list allows all the pending commands to be viewed on the screen with each pending command being separated on the drop-down list, selecting a specific pending command allows the pending command to be edited again.

7. The system of claim 6, wherein the pending command remains in the forefront of the drop-down list until the pending command is executed, then the next command moves up in order into the forefront of the drop-down list and remains there until it is executed.

8. The system of claim 7, wherein the pending command is editable via the keyboard by selecting the pending command in the drop-down list and performing at least one of (i) selecting the delete option on the keyboard, and (ii) selecting the backspace option on the keyboard such that the characters of the pending command are erased.

9. The system of claim 8, wherein the pending command may be inserted into the drop-down list such that the pending command precedes another command already in the drop-down list and both commands are subsequently separated into separate commands.

10. The system of claim 9, wherein the pending command may be entered via the keyboard by at least one of the following functions of, (i) dragging and dropping the pending command to and from the command-line interface, and (ii) cutting and pasting the pending command from one drop-down list location to another drop-down list location.

11. The system of claim 10, wherein the drop-down list provides historical and contextual data that is saved until the user deletes such data, such data includes the directory the user was in when the user typed the command, the environment variable at the time the command was entered and the time the command was entered.
